(19) United States
(12) Patent Application Publication
(10) Pub. No.: US 2017/0060933 A1
(43) Pub. Date: Mar. 2, 2017

(54) METHOD AND SYSTEM FOR VALIDATION OF AN ONLINE PROFILE

(71) Applicant: MasterCard International Incorporated, Purchase, NY (US)

(72) Inventor: Jason A. FELDMAN, New York, NY (US)

(73) Assignee: MASTERCARD INTERNATIONAL INCORPORATED, Purchase, NY (US)

(21) Appl. No.: 14/834,850

(22) Filed: Aug. 25, 2015

(51) Int. Cl. G06F 17/30

(52) U.S. Cl. CPC G06F 17/30371; G06F 17/30702; G06F 17/30312

(57) ABSTRACT

A method for validating user-submitted profile data includes: receiving, by a receiving device, profile data and a user identifier from a first entity, wherein the profile data and the user identifier are associated with a user and where the profile data includes a plurality of unverified data values; transmitting, by a transmitting device, at least the user identifier to a second entity; receiving, by the receiving device, a plurality of corresponding data values from the second entity; and validating, by a processing device, at least one unverified data value of the plurality of unverified data values based on a correspondence to a corresponding data value of the plurality of corresponding data values.

### FIELD

The present disclosure relates to the validation of user-submitted profile data, specifically the use of an external, previously validated data source to validate information supplied by a user in conjunction with an online profile to ensure accuracy of user-submitted information.

### BACKGROUND

When users of computing devices visit various websites on the Internet, or use application programs that are connected to the Internet or are otherwise online, they are often asked by the website or program to provide information about themselves. These services often request user information, such as their gender, age range, exact age, income range, etc. for a variety of reasons, such as for advertising, product development, market research, etc. that may leverage these data points. However, websites and programs often do not use any methods to attempt to verify the information submitted by a user beyond an e-mail address, and instead rely on the user's good faith that they are entering their information honestly.

In many instances, it may not adversely affect an online service if the user provides information that may be inaccurate, such as misrepresents their age. However, for some online services, the accuracy of user-submitted information may be important. For instance, online dating services often seek to match two users together based on their self-submitted information both about themselves, and what they are seeking in a partner. It may therefore be problematic if a user that is seeking a female is matched with a second user who self-selects themselves to be female, but is actually a male, for example. In such instances, the lack of validation that is performed on the user-submitted information can have an adverse effect on a service's user, which can therefore reflect negatively on the service itself.

Thus, there is a need for a technical solution where a service can, in an automated and computationally efficient fashion, validate user-submitted data using independently verified data available from at least one additional, external source. By verifying the data submitted by the user independently, the service can ensure that the user information is accurate. This may increase the value of the benefits the service can provide the user and other users and entities as well as improve the quality of insights or products built or derived from the user data.

### SUMMARY

The present disclosure provides a description of systems and methods for validating user-submitted profile data.

A method for validating user-submitted profile data includes: receiving, by a receiving device, profile data and a user identifier from a first entity, wherein the profile data and the user identifier are associated with a user and where the profile data includes a plurality of unverified data values; transmitting, by a transmitting device, at least the user identifier to a second entity; receiving, by the receiving device, a plurality of corresponding data values from the second entity; and validating, by a processing device, at least one unverified data value of the plurality of unverified data values based on a correspondence to a corresponding data value of the plurality of corresponding data values.

Another method for validating user-submitted profile data includes: receiving, by a receiving device, profile data and a user identifier from a first entity, wherein the profile data and the user identifier are associated with a user and where the profile data includes a plurality of unverified data values; transmitting, by a transmitting device, at least the user identifier and one or more unverified data values of the plurality of unverified data values to a second entity; receiving, by the receiving device, an indication of validity for each of the transmitted one or more unverified data values, wherein the indication of validity indicates if the corresponding unverified data value is valid or not; and updating, by a processing device, the one or more unverified data values of the plurality of unverified data values based on the corresponding indication of validity.

A system for validating user-submitted profile data includes: a processing device; a receiving device configured to receive profile data and a user identifier from a first entity, wherein the profile data and the user identifier are associated with a user and where the profile data includes a plurality of unverified data values; and a transmitting device configured to transmit at least the user identifier to a second entity, wherein the receiving device is further configured to receive a plurality of corresponding data values from the second entity, and the processing device is configured to validate at least one unverified data value of the plurality of unverified data values based on a correspondence to a corresponding data value of the plurality of corresponding data values.

Another system for validating user-submitted profile data includes: a processing device; a receiving device configured to receive profile data and a user identifier from a first entity, wherein the profile data and the user identifier are associated with a user and where the profile data includes a plurality of unverified data values; and a transmitting device is configured to transmit at least the user identifier and one or more unverified data values of the plurality of unverified data values to a second entity, wherein the receiving device is further configured to receive an indication of validity for each of the transmitted one or more unverified data values, wherein the indication of validity indicates if the corresponding unverified data value is valid or not; and updating, by a processing device, the one or more unverified data values of the plurality of unverified data values based on the corresponding indication of validity.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for validating user-submitted profile data in accordance with exemplary embodiments.

FIG. 2 is a block diagram illustrating the processing server of FIG. 1 for validating user-submitted profile data in accordance with exemplary embodiments.

FIG. 3 is a flow diagram illustrating a process for validating user-submitted profile data using the system of FIG. 1 in accordance with exemplary embodiments.

FIG. 4 is a flow diagram illustrating a process for validating user-submitted profile data using the processing server of FIG. 2 in accordance with exemplary embodiments.

FIG. 5 is a diagram illustrating a graphical user interface of a computing device for the validation of user-submitted profile data in accordance with exemplary embodiments.

FIGS. 6 and 7 are flow charts illustrating exemplary methods for validating user-submitted profile data in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Validating User-Submitted Profile Data

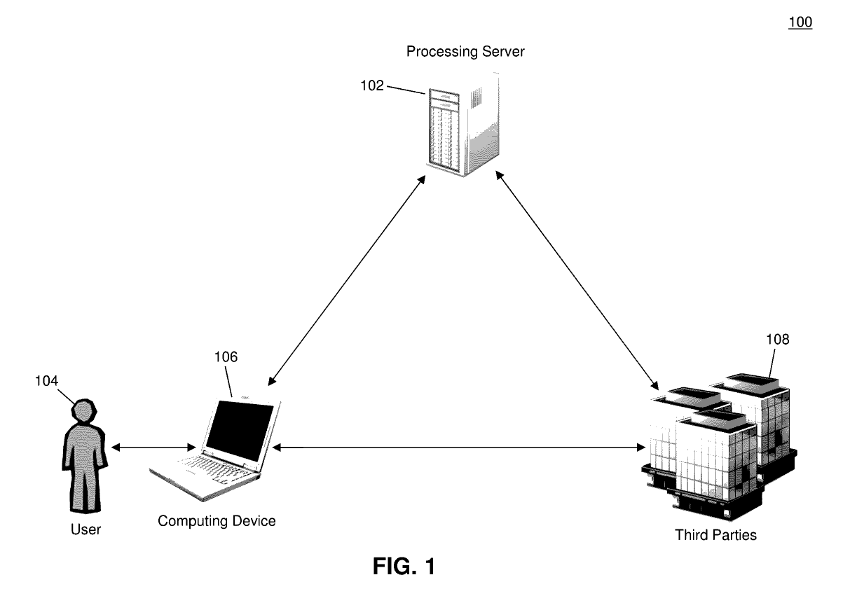

FIG. 1 illustrates a system 100 for the validation of user-submitted profile data using verified data values from an external data source.

The system 100 may include a processing server 102. The processing server 102, discussed in more detail below, may be configured to validate user-submitted profile data. The processing server 102 may receive a plurality of data values from a user 104 via a computing device 106. The computing device 106 may be any type of computing device suitable for performing the functions discussed herein, such as a desktop computer, laptop computer, notebook computer, tablet computer, cellular phone, smart phone, smart watch, wearable computing device, implanted computing device, smart television, etc. The computing device 106 may collect data values from the user 104 via one or more input devices, and may transmit the data values to the processing server 102 via one or more networks using associated network protocols, such as via the Internet.

The processing server 102 may receive the plurality of data values and validate the data values using the methods discussed herein. In some embodiments, the processing server 102 may receive the data values in conjunction with a service being provided to the user 104. For instance, the processing server 102 may be configured to, or be a part of a system configured to, provide a service to the user 104 via the computing device 106, such as an online retailer, dating service, resume, employment or job-posting service, referral service, financial institution, data collection agency, credit bureau, advertising agency, social network, news provider, etc. For example, the processing server 102 may be a part of a computing system that operates a dating service for which the user 104 is registering. In another example, the processing server 102 may be external to a system operating an online dating service, and may receive the data values from the user 104 as forwarded by the online dating service for validation.

In some embodiments, the plurality of data values received by the processing server 102 may be provided by the user 102 based on the corresponding service. For instance, the data values provided by the user 102 in conjunction with a social network may be different from the data values provided by the user 102 in conjunction with a financial institution. The data values may include any type of data associated with a user 104 that may be validated via an external entity and/or secondary data source using the methods and systems discussed herein, such as demographic data (e.g., age, gender, income, geographic location, residential status, familial status, education, occupation, marital status, hair color, eye color, etc.), financial data (e.g., credit rating, credit limit, available credit, spending budget, transaction behavior, etc.), health data (e.g., fitness level, height, weight, allergies, etc.), etc.

The plurality of data values received by the processing server 102 may include one or more unverified data values. An unverified data value may be a data value whose content has not been verified by an external entity or using a secondary data source. For instance, the user 104 may provide their age and gender to a service upon registration, which may be unverified. The processing server 102 may be configured to use the methods and systems discussed herein to verify the user-submitted data.

The system 100 may also include one or more third parties 108. The third parties 108 may include entities configured to provide secondary data values to the processing server 102 for use in validation, and/or entities configured to validate user-submitted data as provided by the processing server 102. For example, in some instances, the processing server 102 may request one or more data values from a third party 108 corresponding to data values provided by the user 104. In some other instances, the processing server 102 may provide an identification value to the third party 108, such as a financial institution, credit bureau, government agency, data collection agency, research agency, etc. for use in identifying the data values associated with the user 104. The identification value may be, for example, a name, e-mail address, username, street address, phone number, transaction account number, device identifier, etc., or a combination thereof. In some cases, the identification value may be associated with a consumer device, such as a cookie identifier, a device fingerprint (e.g., including data points associated with a device suitable for identification of a computing device and/or a user thereof), media access control address, etc. In some instances, the identification value may be unique to the user 104. The third party 108 may then identify data values associated with the user 104 using the identification value.

The third party 108 may provide the identified data values to the processing server 102, for use by the processing server in validating the user-submitted data values. In some embodiments, the processing server 102 may identify specific data values to be identified and provided by the third party 108. For example, the processing server 102 may specifically request an age and gender for the user 104. In some instances, the third party 108 may provide previously validated data values to the processing server 102. The processing server 102 may then compare the data values received from the third party 108 to the data values provided by the user 104 to validate the user-submitted data values.

In some instances, a data value may be validated if the user-submitted value corresponds to the value provided by the third party 108. In other instances, a data value may be validated if the corresponding data value is a prior validated data value. In some embodiments, the processing server 102 may be configured to store a data value as corresponding to the user 104 upon validation, and may also be configured to remove, or include an indication of invalidity, a data value that is determined to be invalid. A determination of invalidation may be inferred via a lack of validation, or may be determined in instances where a data value received from a third party 108 is different from the data value submitted by the user 104. In some cases, the processing server 102 may store both data values.

In some embodiments, the processing server 102 may receive data values from a plurality of different third parties 108. In such an instance, the processing server 102 may perform the validation of user-submitted data values based on data values provided by the plurality of different third parties 108. In some instances, validation may be based on the number of third parties 108 whose provided data value matches the user-submitted data value. In some embodiments, the processing server 102 may calculate a percentage or other value as a representation of a likelihood of the accuracy of a user-submitted data value. For example, if the user 104 submits their age as being 34, and the processing server 102 requests the age for the user 104 from eight different third parties 108, with six third parties 108 providing that the age of the user 104 is 34, and the other two providing that the age of the user 104 is 35, then the processing server 102 may determine that the user-submitted age is 75% chance of being accurate, for example. Of course, the results from the third parties 108 might be weighted according to their comparative authority, e.g., government official records might be given more weight than records that might have been self-reported or inferred. In some instances, the processing server 102 may also utilize time weighting and may consider the time at which data was captured by the third parties 108. For instance, if a third party 108 provides that the age of the user 104 is 34, but captured the age from the user two years earlier, the processing server 102 may weigh the age provided by that third party 108 accordingly or may modify the age based on the time weighting. In some cases, the processing server 102 may provide a cutoff to third parties 108 for the validation data, such that information provided by the third parties 108 must be captured within a predetermined period of time. In some instances, the period of time may be based on the data values being provided, such as a longer period of time for education, but a shorter period of time for occupation.

In another example, the processing server 102 may receive transaction data associated with payment transactions involving the user 104 for use in validating user-submitted data. For instance, a third party 108 that is a payment network or financial institution, such as an issuing bank associated with the user 104, may provide transaction data or purchase behavior information associated thereto to the processing server 102, which may be used to validate data submitted by the user 104. In an example, the geographic location for multiple transactions or an estimated residence location based on transaction data may be provided by the third party 108 payment network or identified by the processing server 102 from provided transaction data, which may be used to validate the zip code or residence city submitted by the user 104. In another example, user-submitted eating habits, exercise habits, body type, etc. may be validated based on associated purchases included in the transaction data, such as a gym membership and/or sporting goods purchases used to validate a user that submits that they are athletic and/or active, clothing purchases with size information included to validate a user's height and/or body type, etc.

In some embodiments, the processing server 102 may be configured to provide data values to a third party 108 for validation. For instance, the processing server 102 may transmit a plurality of data values received from the user 104, along with the identification value, to one or more third parties 108. The third party 108 may then validate the data values using secondary data sources of the data values and may return indications of validation for each data value to the processing server 102. The processing server 102 may then process the user-submitted data values accordingly. Processing may include storing validated data values and removing invalid data values, indicating stored data values as valid or invalid, calculating accuracy likelihoods, replacing a data values with a validated data values as provided by the third party 108, etc. In some instances, the processing server 102 may provide an indication of invalidity and/or a validated data value to the user 104 for confirmation. For example, the user 104 may replace an invalid data value with a different data value, or confirm a validated data value as provided by the third party 108 and/or determined by the processing server 102.

In an example, the processing server 102 may be associated with an online dating service. The user 104 may use the computing device 106 to register with the online dating service, and, as part of the registration, may provide a plurality of user-submitted data values to the processing server 102 (e.g., via the service), which may include, for example, age, gender, occupation, income, and geographic location, as well as an identification value, which may include, for example, a transaction account number provided for verification. The processing server 102 may receive the data values and may request data values for validation from three third parties 108, a mobile network operator, a financial institution, and a credit bureau using the provided identification value. The third parties 108 may each return available data values. For instance, the mobile network operator may return a geographic location (e.g., identified using a mobile device associated with the user 104), the financial institution may return an occupation and income (e.g., identified from account information and transaction history), and the credit bureau may return each of the data values. The processing server 102 may then validate each of the user-submitted data values based on those received from the third parties 108. As a result, the processing server 108 may verify the information provided by the user 104 that may be presented to other users, or used for the matching of the user 104 with other users. In some instances, if another user views a profile associated with the user 104, the validation status of each data value may be indicated, such as by indicating valid, invalid, or a calculated accuracy value.

Using the methods and systems discussed herein, the processing server 102 may be able to provide for validation of user-submitted data values that ensure accuracy of user-submitted information for user profiles used in conjunction with various services. By utilizing data provided by external data sources, the processing server 102 may be able to validate user-submitted data values, which may include the modification or replacement of user-submitted data values with known, correct data values. As a result, the processing server 102 can ensure that inaccurate information is not provided and used in conjunction with a service, which may therefore prevent fraud or other negative actions from occurring. Accordingly, the methods and systems discussed herein provide a technical solution whereby user-submitted data values are verified using an external data source.

### Processing Server

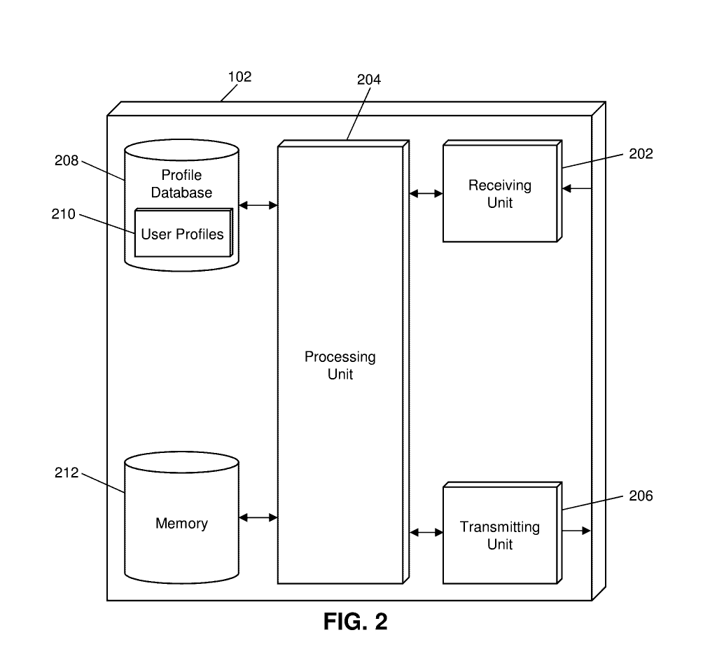

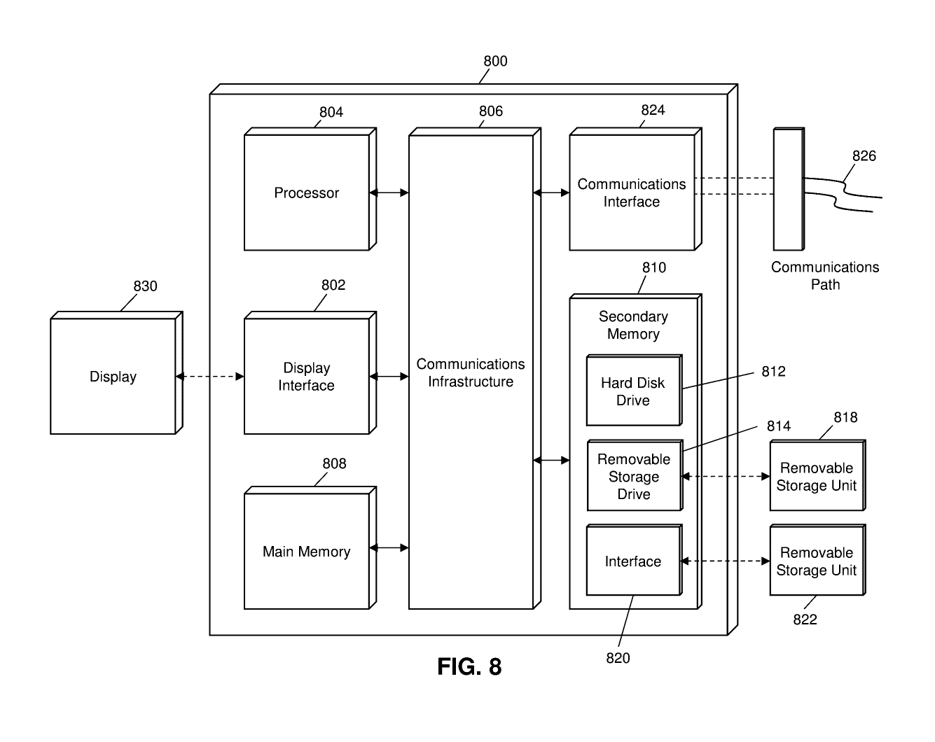

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive a plurality of data values from a first entity, such as from the user 104 via the computing device 106, which may be transmitted to the processing server 102 via a third party entity (e.g., a service, such as an online dating service). The plurality of data values may include a plurality of user-submitted data values, and may also be accompanied by a user identifier. The user identifier may be a unique value associated with the user 104 to whom the user-submitted data values correspond, such as a transaction account number. In some embodiments, the user identifier may be an encrypted value, such as encrypted via a one-way encryption method such that the unencrypted value may not be identified by the processing server 102. In some instances, the receiving unit 202 may be configured to encrypt the user identifier upon receipt.

The processing server 102 may also include a profile database 208. The profile database 208 may be configured to store a plurality of user profiles 210. Each user profile 210 may be configured to store data related to a user 104 including at least the received user identifier and plurality of user-submitted data values. In some instances, each user profile 210 may include additional data, such as associated with the service provided to the user 104. For example, if the service is an online dating service, the user profile 210 may further include associated information, such as dating matches, contact information, user biography, picture data, etc. User-submitted data values received by the receiving unit 202 may be stored in a corresponding user profile 210 in the profile database 208.

The processing server 102 may also include a processing unit 204. The processing unit 204 may be configured to perform the functions of the processing server 102 discussed herein as will be apparent to persons having skill in the relevant art. The processing unit 204 may be configured to identify user profiles 210 that correspond to received user-submitted data values based on user identifiers and may be configured to store received data values in the identified user profile 210, and/or generate a new user profile 210 if applicable. The processing unit 204 may also be configured to validate user-submitted data values. The processing unit 204 may be configured to generate data value requests and data validation requests. Data value requests may include at least a user identifier, and may also include one or more data values that are to be requested. Data validation requests may include a user identifier and one or more data values that are to be validated.

The processing server 102 may further include a transmitting unit 206. The transmitting unit 206 may be configured to transmit data over one or more networks via one or more network protocols. The transmitting unit 206 may be configured to transmit data value requests and data validation requests to third parties 108 via suitable networks and using suitable communication protocols. The receiving unit 202 may be further configured to receive responses from the third parties 108. Responses may include user data values and/or indications of validity or invalidity.

The processing unit 204 may be configured to validate user-submitted data values based on the data included in the responses received by the receiving unit 202. For example, the processing unit 204 may validate user-submitted data values based on comparison to received data values or based on a received indication of validity. The processing unit 204 may invalidate a user-submitted data value based on a corresponding received data value being different or based on a received indication of invalidity. In some embodiments, the processing unit 204 may be configured to update data values stored in the respective user profile 210, such as by indicating validated user data values as valid, indicating invalid data values as invalid, replacing invalid data values with validated (e.g., if received) data values, removing invalid data values, etc.

In some instances, the processing unit 204 may use one or more data values to match response data to user-submitted data prior to validation of the user-submitted data. For example, the processing unit 204 may identify correspondences between one or more data values in the response data to the user-submitted data to ensure that the response data corresponds to the user 104. The data values used for matching may be the user identifier, or, in some instances, the data values used for matching may be considered a user identifier for purposes discussed herein. For example, a combination of the user's age, zip code, gender, and occupation may be suitable for use as a user identifier to ensure that response data is associated with the user 104 and usable to validate the user-submitted data.

In some embodiments, the processing unit 204 may be configured to calculate a value associated with the validity and/or accuracy of a user-submitted data value. The value may be based on the user-submitted data value and the value of corresponding data values received by the receiving unit 202 from third parties 108 and/or third party indications of validity. In such embodiments, the processing unit 204 may store the calculated value in the user profile 210.

In some embodiments, the transmitting unit 206 may be further configured to transmit validated data values. In such an embodiment, the transmitting unit 206 may transmit validated data values to an entity, such as associated with the service being provided to the user 104. For instance, if the user 104 provided the user-submitted data values to an online dating service, which included the processing server 102 or forwarded the values to the processing server 102 for validation, the transmitting unit 206 may be configured to transmit the results of the validation to the online dating service.

The processing server 102 may also include a memory 212. The memory 212 may be configured to store data suitable for performing the functions of the processing server 102 discussed herein. For example, the memory 212 may be configured to store rules or algorithms for comparing data values, for generating data value or data validation requests, for encrypting user identifiers, for calculating data value accuracy likelihoods, etc. Additional data that may be stored in the memory 212 will be apparent to persons having skill in the relevant art.

### Processes for Validating User-Submitted Data Values

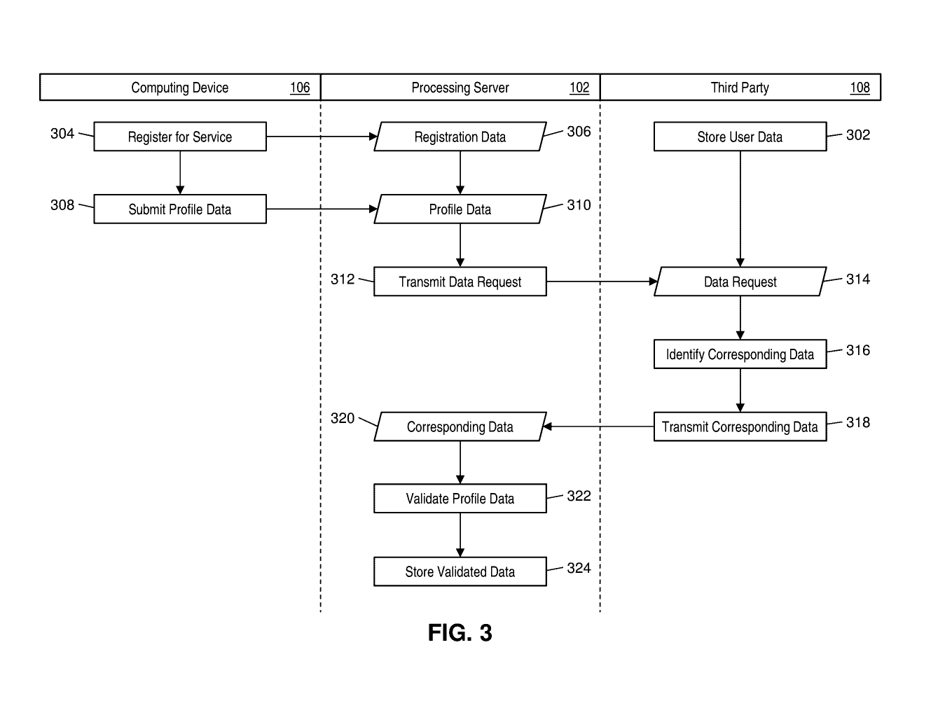

FIG. 3 illustrates a process for the validation of user-submitted data values using a third party data source in the system 100.

In step 302, a third party 108 may store user data associated with a user 104. The third party 108 may receive and store a plurality of user data value associated with the user 104 using methods that will be apparent to persons having skill in the relevant art. In step 304, the user 104 may register with a service using the computing device 106. The service may be, for instance, an online dating service. As part of the registration, the user 104 may enter registration data in the computing device 106, which may be transmitted to the processing server 102. In step 306, the receiving unit 202 of the processing server 102 may receive the registration data. The registration data may include a username, password, user identifier, and any other data suitable for use in registering the user 104 with the service. In some cases, registration data may include data associated with the computing device 106, such as a device identifier (e.g., media access control address, registration number, serial number, etc.), web browsing application program data, internet protocol address, operating system data, etc. In some instances, step 306 may include the generation of a user profile 210 by the processing unit 204 of the processing server 102 for storage in the profile database 208.

In step 308, the user 104 may submit profile data via the computing device 106 as part of their user of the registered service. The profile data may include a plurality of user-supplied data values, which may correspond to the service being provided. For instance, the data values that comprise the user profile for a dating service may be different than the data values that comprise a user profile for a financial institution. The plurality of data values may be submitted to the processing server 102 and, in step 310, received by the receiving unit 202.

In step 312, the transmitting unit 206 of the processing server 102 may transmit a data request to the third party 108. The data request may include at least the user identifier provided by the user 104 via the computing device 106 in step 304 and/or step 308. In some embodiments, the data request may also include one or more requested data values, or may include one or more data values for validation. In step 314, the third party 108 may receive the data request. In step 316, the third party 108 may identify data corresponding to the received data request. In instances where the data request is a request for values, step 316 may include identifying user data values using the user identifier that correspond to the requested data values. In instances where the data request is a request for validation, step 316 may include identifying data values corresponding to the data values included in the request, and validating the data values included in the request based on matching of the values.

In step 318, the third party 108 may transmit the identified data to the processing server 102. In step 320, the receiving unit 202 of the processing server 102 may receive the corresponding data. The corresponding data may include one or more data value associated with the user 104, as requested, or may include one or more indications of validity of provided data values. In step 322, the processing unit 204 of the processing server 102 may validate the user-submitted data values using the received corresponding data. If the corresponding data includes data values, validation may be based on a correspondence between the user-submitted data values and the data values received from the third party 108. If the corresponding data includes indications, the validation may be based on the indication of validity for each of the data values. In step 324, the processing unit 204 may store the validated data in the corresponding user profile 210. In some instances, the processing unit 204 may also store invalid data or data that has not been fully validated, and may also store an indication based thereon.

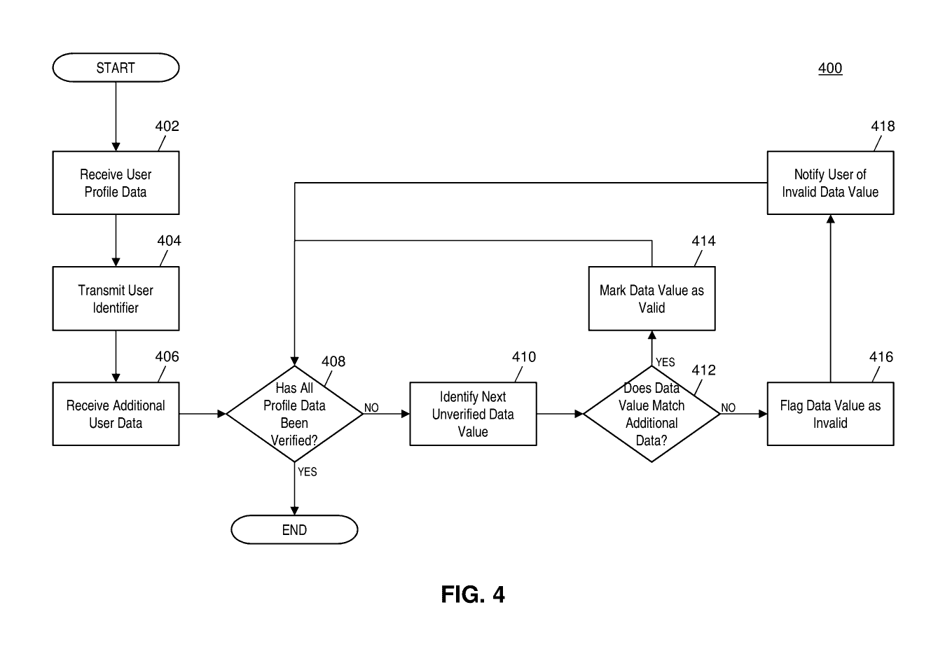

FIG. 4 illustrates a process 400 for the validation of user-submitted profile data as performed by the processing server 102 of FIG. 2 and in the system 100.

In step 402, the receiving unit 202 of the processing server 102 may receive user profile data. The user profile data may include data associated with a user service, such as an online dating or employment service, including at least a user identifier and a plurality of data values. In some instances, the user identifier may be an encrypted value. In other instances, the receiving unit 202 and/or processing unit 204 of the processing server 102 may encrypt the user identifier upon receipt.

In step 404, the transmitting unit 206 of the processing server 102 may transmit at least the user identifier to one or more third parties 108. In some instances, the transmission may also include one or more data values for request or validation. In step 406, the receiving unit 202 may receive additional user data from the third parties 108 in response to the transmitted request(s), which may include other user data values and/or indications of validity. In step 408, the processing unit 204 may determine if all of the user-submitted data values have been verified. If each of the data values have not been verified, then the process 400 may proceed to step 410.

In step 410, the processing unit 204 may identify the next data value submitted by the user 104 and received in step 402 that has not yet been verified. In some instances, the processing unit 204 may follow a specific order (e.g., as stored in the memory 212) for the verification of data values. In other instances, the order in which data values are verified may be random or pseudo-random. In step 412, the processing unit 204 may determine if the identified data value that is to be verified matches (e.g., has the same, a similar, or equivalent value to) a data value received in the additional user data from one or more third parties 108. If the data value matches, then the data value may be determined to be validated. In step 414, the processing unit 204 may mark (e.g., in the user profile 210) the data value as having been validated. In some instances, a data value may be determined as being valid if the additional user data includes an indication of validity for the respective data value. The process may then return to step 408 to continue verifying data values.

If, in step 412, the processing unit 204 determines that the user-submitted data value does not match the received data values from the third parties 108, then, in step 416, the processing unit 204 may flag the data value as being invalid. In some instances, this may include indicating the data value as invalid in the corresponding user profile 210. In other instances, the data value may be removed from the user profile 210. In some embodiments, if a valid data value is received in the additional user data, the invalid data value may be replaced in the user profile 210 with the valid data value.

In step 418, the transmitting unit 206 may transmit a notification to the user 104 (e.g., via the computing device 106) that the data value was determined to be invalid. In some instances, the notification may include a reason or other information associated with the determination of invalidity. For example, if the data value is the user's age, the notification may include one or more third parties 108 and their provided age of the user 104 as a reason for invalidation. In some instances, the processing server 102 may be configured to predict a valid data value for presentation to the user 104 for confirmation. For example, the processing unit 204 of the processing server 102 may identify user profiles 210 in the profile database 208 that include similar data values to verified data values for the user 104 and may predict a data value to be used in place of the invalid data value based on the verified data values for that field in the similar user profiles 210. The predicted data value may then be presented to the user 104 via the computing device 106 for confirmation.

In instances where the user-submitted data value may be replaced, the notification may notify the user 104 of the replacement of their submitted data value with the valid data value received from the third party 108. Then the process may proceed to step 408 to continue verifying data values until each data value has been verified (e.g., determined to be valid or invalid).

### Graphical User Interface

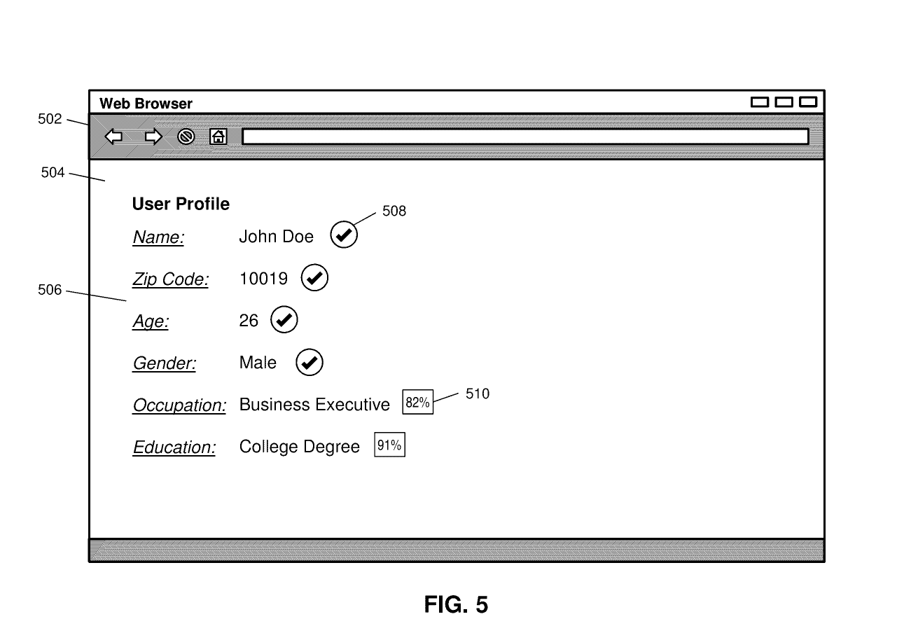

FIG. 5 illustrates a graphical user interface of a computing device, such as the computing device 106 of the user 104, for viewing user profile data verified using the methods and systems discussed herein.

FIG. 5 illustrates a web browser 502, such as displayed via execution of a corresponding application program on the computing device 106. The web browser 502 may display a web page 504. The web page 504 illustrated in FIG. 5 may be a web page corresponding to the service with which the user 104 registered and may be configured to display profile data, which may include a plurality of data values 506. Each of the plurality of data values 506 may correspond to a data value submitted by the user 104, such as during the registration process.

The web page 504 may also display, for each data value 506, a validation indication 508 or a validation value 510. The validation indication 508 may be an image, icon, or other type of indicator that is indicative that the corresponding data value 506 has been validated using the processes discussed herein. In the example illustrated in FIG. 5, the user's name, zip code, age, and gender have each been validated by the processing server 102.

The validation value 510 may be a value that is indicative of the accuracy of the user-submitted data value, identified by the processing server 102 using the processes discussed herein. In the example illustrated in FIG. 5, the user's occupation is validated with 82% accuracy and the user's education is validated with 91% accuracy. The accuracy may be based on, for instance, the user's occupation and education as provided by a plurality of third parties 108 used to validate the user submitted data value that is listed as a data value 506 in the web page 504. Additional methods for indicating validity and value calculations of validity will be apparent to persons having skill in the relevant art.

### First Exemplary Method for Validating User-Submitted Profile Data

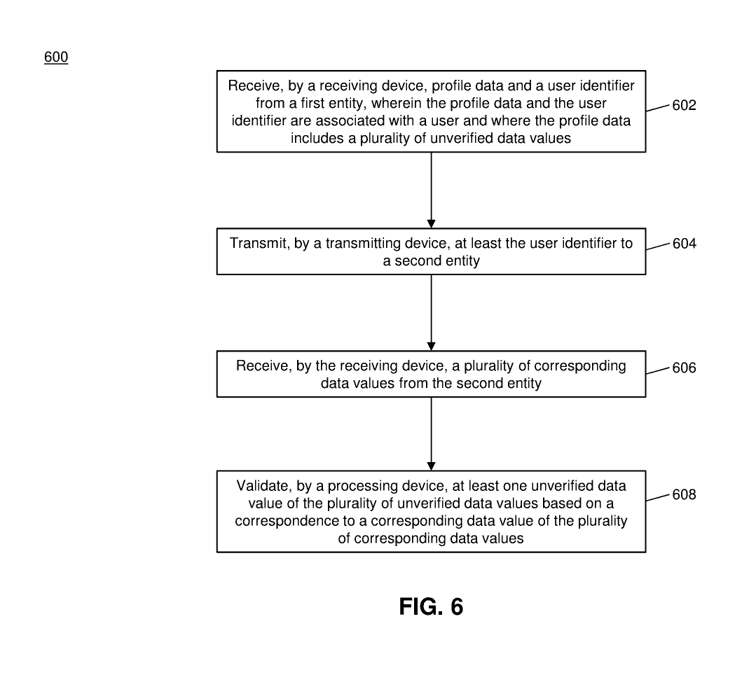

FIG. 6 illustrates a method 600 for the validation of user-submitted profile data using data received from two external data sources.

In step 602, profile data and a user identifier are received by a receiving device (e.g., the receiving unit 202) from a first entity, wherein the profile data and the user identifier are associated with a user (e.g., the user 104) and where the profile data includes a plurality of unverified data values. In step 604, at least the user identifier is transmitted to a second entity (e.g., a third party 108) by a transmitting device (e.g., the transmitting unit 206).

In step 606, a plurality of corresponding data values are received by the receiving device 202 from the second entity 108. In one embodiment, the plurality of corresponding data values may be verified data values. In step 608, at least one unverified data value of the plurality of unverified data values is validated by a processing device (e.g., the processing unit 204) based on a correspondence to a corresponding data value of the plurality of corresponding data values.

In one embodiment, transmitting the user identifier may include transmitting one or more data fields corresponding to one or more unverified data values of the plurality of unverified data values, and each corresponding data value of the plurality of corresponding data values may correspond to the transmitted one or more data fields. In some embodiments, the method 600 may further include encrypting, by the processing device 204, the user identifier with a one-way encryption prior to transmitting the user identifier to the second entity 108. In a further embodiment, the user identifier may be encrypted immediately upon receipt by the receiving device 202. In one embodiment, the method 600 may further include storing, in a profile database (e.g., the profile database 208), a user profile (e.g., user profile 210), wherein the user profile 210 includes at least the user identifier and each validated data value.

### Second Exemplary Method for Validating User-Submitted Profile Data

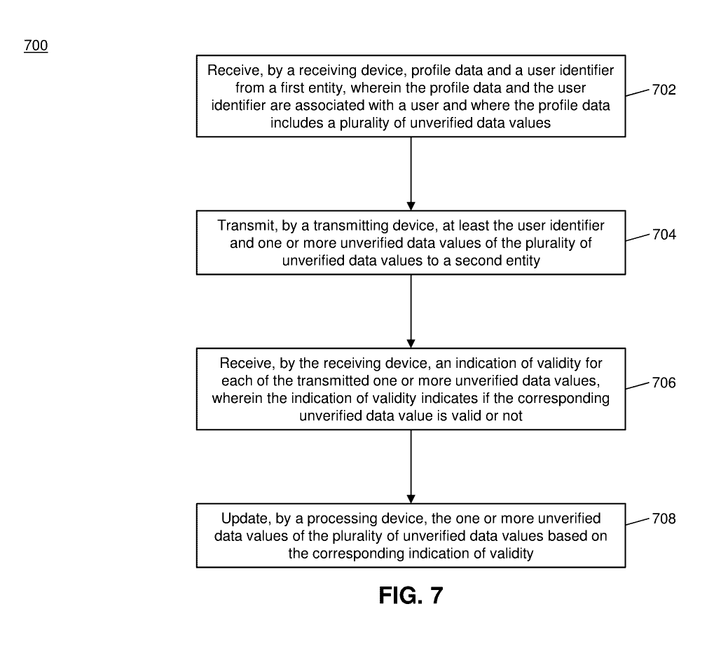

FIG. 7 illustrates a method 700 for validating user-submitted profile data using indications provided by an external data source.

In step 702, profile data and a user identifier may be received by a receiving device (e.g., the receiving unit 202) from a first entity, wherein the profile data and the user identifier are associated with a user (e.g., the user 104) and where the profile data includes a plurality of unverified data values. In step 704, at least the user identifier and one or more unverified data values of the plurality of data values may be transmitted by a transmitting device (e.g., the transmitting unit 206) to a second entity (e.g., a third party 108).

In step 706, an indication of validity for each of the transmitted one or more unverified data values may be received by the receiving device 202, wherein the indication of validity indicates if the corresponding unverified data value is valid or not. In step 708, the one or more unverified data values of the plurality of unverified data values may be updated by a processing device (e.g., the processing unit 204) based on the corresponding indication of validity.

In one embodiment, the indication of validity may further include a verified data value if the indication of validity indicates that the corresponding unverified data value is not valid, and updating the one or more unverified data values includes replacing an unverified data value that is indicated as being not valid with the corresponding verified data value. In some embodiments, updating the one or more unverified data values includes removing an unverified data value that is indicated as being not valid.

In one embodiment, the method 700 may further include encrypting, by the processing device 204, the user identifier with a one-way encryption prior to transmitting the user identifier to the second entity 108. In a further embodiment, the user identifier may be encrypted immediately upon receipt by the receiving device 202. In some embodiments, the method 700 may also include storing, in a profile database (e.g., the profile database 208), a user profile (e.g., user profile 210), wherein the user profile 210 includes at least the user identifier and each updated unverified data value.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 6, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3, 4, 6, and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for validating user-submitted profile data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for validating user-submitted profile data, comprising:
receiving, by a receiving device, profile data and a user identifier from a first entity, wherein the profile data and the user identifier are associated with a user and where the profile data includes a plurality of unverified data values;
transmitting, by a transmitting device, at least the user identifier to a second entity;
receiving, by the receiving device, a plurality of corresponding data values from the second entity; and
validating, by a processing device, at least one unverified data value of the plurality of unverified data values based on a correspondence to a corresponding data value of the plurality of corresponding data values.

2. The method of claim 1, wherein
transmitting the user identifier includes transmitting one or more data fields corresponding to one or more unverified data values of the plurality of unverified data values, and
each corresponding data value of the plurality of corresponding data values corresponds to the transmitted one or more data fields.

3. The method of claim 1, wherein the plurality of corresponding data values are verified data values.

4. The method of claim 1, further comprising:
encrypting, by the processing device, the user identifier with a one-way encryption prior to transmitting the user identifier to the second entity.

5. The method of claim 4, wherein the user identifier is encrypted immediately upon receipt by the receiving device.

6. The method of claim 1, further comprising:
storing, in a profile database, a user profile, wherein the user profile includes at least the user identifier and each validated data value.

7. A method for validating user-submitted profile data, comprising:
receiving, by a receiving device, profile data and a user identifier from a first entity, wherein the profile data and the user identifier are associated with a user and where the profile data includes a plurality of unverified data values;
transmitting, by a transmitting device, at least the user identifier and one or more unverified data values of the plurality of unverified data values to a second entity;
receiving, by the receiving device, an indication of validity for each of the transmitted one or more unverified data values, wherein the indication of validity indicates if the corresponding unverified data value is valid or not; and
updating, by a processing device, the one or more unverified data values of the plurality of unverified data values based on the corresponding indication of validity.

8. The method of claim 7, wherein
the indication of validity further includes a verified data value if the indication of validity indicates that the corresponding unverified data value is not valid, and
updating the one or more unverified data values includes replacing an unverified data value that is indicated as being not valid with the corresponding verified data value.

9. The method of claim 7, wherein updating the one or more unverified data values includes removing an unverified data value that is indicated as being not valid.

10. The method of claim 7, further comprising:
encrypting, by the processing device, the user identifier with a one-way encryption prior to transmitting the user identifier to the second entity.

11. The method of claim 10, wherein the user identifier is encrypted immediately upon receipt by the receiving device.

12. The method of claim 7, further comprising:
storing, in a profile database, a user profile, wherein the user profile includes at least the user identifier and each updated unverified data value.

13. A system for validating user-submitted profile data, comprising:
a processing device;
a receiving device configured to receive profile data and a user identifier from a first entity, wherein the profile data and the user identifier are associated with a user and where the profile data includes a plurality of unverified data values; and
a transmitting device configured to transmit at least the user identifier to a second entity, wherein
the receiving device is further configured to receive a plurality of corresponding data values from the second entity, and
the processing device is configured to validate at least one unverified data value of the plurality of unverified data values based on a correspondence to a corresponding data value of the plurality of corresponding data values.

14. The system of claim 13, wherein
transmitting the user identifier includes transmitting one or more data fields corresponding to one or more unverified data values of the plurality of unverified data values, and
each corresponding data value of the plurality of corresponding data values corresponds to the transmitted one or more data fields.

15. The system of claim 13, wherein the plurality of corresponding data values are verified data values.

16. The system of claim 13, wherein the processing device is further configured to encrypt the user identifier with a one-way encryption prior to transmitting the user identifier to the second entity.

17. The system of claim 16, wherein the user identifier is encrypted immediately upon receipt by the receiving device.

18. The system of claim 13, further comprising:
a profile database configured to store a user profile, wherein the user profile includes at least the user identifier and each validated data value.

19. A system for validating user-submitted profile data, comprising:
a processing device;
a receiving device configured to receive profile data and a user identifier from a first entity, wherein the profile data and the user identifier are associated with a user and where the profile data includes a plurality of unverified data values; and
a transmitting device is configured to transmit at least the user identifier and one or more unverified data values of the plurality of unverified data values to a second entity, wherein
the receiving device is further configured to receive an indication of validity for each of the transmitted one or more unverified data values, wherein the indication of validity indicates if the corresponding unverified data value is valid or not; and
updating, by a processing device, the one or more unverified data values of the plurality of unverified data values based on the corresponding indication of validity.

20. The system of claim 19, wherein
the indication of validity further includes a verified data value if the indication of validity indicates that the corresponding unverified data value is not valid, and
updating the one or more unverified data values includes replacing an unverified data value that is indicated as being not valid with the corresponding verified data value.

21. The system of claim 19, wherein updating the one or more unverified data values includes removing an unverified data value that is indicated as being not valid.

22. The system of claim 19, wherein the processing device is further configured to encrypt the user identifier with a one-way encryption prior to transmitting the user identifier to the second entity.

23. The system of claim 22, wherein the user identifier is encrypted immediately upon receipt by the receiving device.

24. The system of claim 19, further comprising:
a profile database configured to store a user profile, wherein the user profile includes at least the user identifier and each updated unverified data value.
